(19) United States
(12) Patent Application Publication
(10) Pub. No.: US 2009/0305905 A1
(43) Pub. Date: Dec. 10, 2009

(54) COMPOSITIONS AND METHODS RELATING TO CHARACTERIZATION AND THERAPEUTIC APPLICATION OF PRISTINE STEM CELLS

(76) Inventor: Robert Bradbury, Saugus, MA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/334,144

(22) Filed: Dec. 12, 2008

Related U.S. Application Data
(60) Provisional application No. 61/013,633, filed on Dec. 13, 2007.
(60) Provisional application No. 61/060,724, filed on Jun. 11, 2008.

(51) Int. Cl. C40B 30/06; C40B 40/02; C40B 60/08

(52) U.S. Cl. 506/10; 506/14; 506/37

(57) ABSTRACT

“Pristine” stem cells are provided by a process of precise selection wherein stem cells exhibiting ideal behavior, good morphology and proper gene expression are selected. Stem cells are divided into pools and observed for optimum speed of growth, proper gene expression levels, and other tests indicative of healthy cell function due to lack of mutation or misrepair of genes. Autologous pools of such “pristine” stem cells provide a source of stem cells having the genome least affected by mutation, and therefore in a more pristine state.

### RELATED APPLICATIONS

This application claims the Paris convention priority of and incorporates by reference U.S. Provisional Patent Applications Ser. Nos. 61/013,633, filed Dec. 13, 2007; and 61/060,724, filed Jun. 11, 2008.

### BACKGROUND

This disclosure relates to compositions and methods for therapeutic utilization of autologous and nonautologous stem cells obtained by multifactor precise identification of minimal genomic variation, proper metabolic rate, ideal morphology, etc.

### SUMMARY

“Pristine” stem cells are provided by a process of precise selection where stem cells exhibiting ideal behavior and gene expression are selected. Stem cells are divided into pools and observed for optimum speed of growth, proper gene expression levels, and other tests indicative of healthy cell function due to lack of mutation and good repair of genes. Pools of the healthy, “pristine” stem cells provide a source of stem cells having the genome least affected by mutation, and therefore in a more pristine state.

According to a feature of the present disclosure, a method is disclosed comprising obtaining stem cells from a stem cell source within an organism; separating and growing aliquots of stem cells to form a plurality of stem cell pools; assaying the health of each stem cell pool by testing each stem cell pool with a plurality of assays that generate data related to the health of each stem cell pool; and electing at least one stem cell pools for therapeutic applications based on the data.

According to a feature of the present disclosure, a composition comprising at least one healthy stem cell pool; wherein the health of each stem cell pool is derived from data from a plurality of assays used to generate data to assess the health of each stem cell pool and a determination of the health of each stem cell pool made from the data; wherein a sample of stem cells is obtained, and the stem cells in the stem cell sample are divided in a plurality of aliquots, and each aliquot is grown into at least one stem cell pool.

According to a feature of the present disclosure, a kit of parts is disclosed comprising reagents and devices for performing a plurality of assays that produce data related to the health of stem cell pools.

### DRAWINGS

The above-mentioned features and objects of the present disclosure will become more apparent with reference to the following description taken in conjunction with the accompanying drawings wherein like reference numerals denote like elements and in which:

FIG. 1 is a flow diagram of an embodiment of a general method for isolating an individual's pristine stem cells; and

FIG. 2 is a flow diagram of an embodiment of a general method for isolating and determining the quality of an individual's pristine stem cells.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, biological, electrical, functional, and other changes may be made without departing from the scope of the present invention. The following detailed description is, therefore, not to be taken in a limiting sense, and the scope of the present invention is defined only by the appended claims. As used in the present disclosure, the term “or” shall be understood to be defined as a logical disjunction and shall not indicate an exclusive disjunction unless expressly indicated as such or notated as “xor.”

“Micro Clonal Stem Cell Pool” (MCSCP) shall refer to a unique stem cell pool derived from a cell or small numbers of cells which have unique life histories and a unique pattern of genome mutations and epigenetic modifications. Cells within each MCSCP are significantly more likely to have highly similar, even identical, genomes and genome expression states compared with cells from other stem cell pools, even in cases where the stem cell pools are derived from the same individual. Current methods using large numbers of tissue cells, either in bulk or after undergoing stem cell selection procedures are unlikely to produce unique clonal Therapeutic Stem Cell Pool (TSCP) due to the individual life histories of large numbers of cells. The behavior of such large numbers stem cells with potentially different genomes is difficult to guarantee in therapeutic applications. This is particularly important given current theories which propose that stem cells may play fundamental roles in the formation of some types of cancer.

Samples of stem cells are obtained and divided into aliquots constituting a Micro Clonal Stem Cell Pool (MCSCP). The quantity of cells in each MCSCP can vary from a single cell to hundreds of cells depending upon the tissue from which they are derived. The primary criteria for the determination of the number of cells shall be those factors, internal to the body (such as hormones and nutrients determining cellular metabolic activity and replication rate) and external environmental factors (such as ionizing or UV radiation) which may contribute to the development of single stem cell genomes containing significantly different mutations. Stem cells taken from single niches within the body, e.g. single hair follicles or single intestinal crypts having similar histories may have largely similar genomes and may be used in larger numbers to create a MCSCP compared with stem cells with significantly different histories from different parts of the body or stem cells from different tissues. Each aliquot is grown into at least one Therapeutic Stem Cell Pool (TSCP) from which cells are taken for assay purposes and subsequent therapies.

According to embodiments, a process is disclosed for deriving pristine stem cells from an organism. Each MCSCP and TSCP has a specific individual genome mutation history. “Pristine” stem cell pools represent at least one pool of stem cells exhibiting indicia that the genome has a minimal level of genome mutation, inaccurate genome repair and other indicia related to cellular health relative to other stem cell pools. To determine the most pristine pools of stem cells, cells from each of a plurality of stem cell pools are tested against different predetermined criteria designed to provide information related to the overall health of the stem cell pool's genome. According to embodiments, such a process may be individualized, whereby the pristine stem cells are specific for an individual.

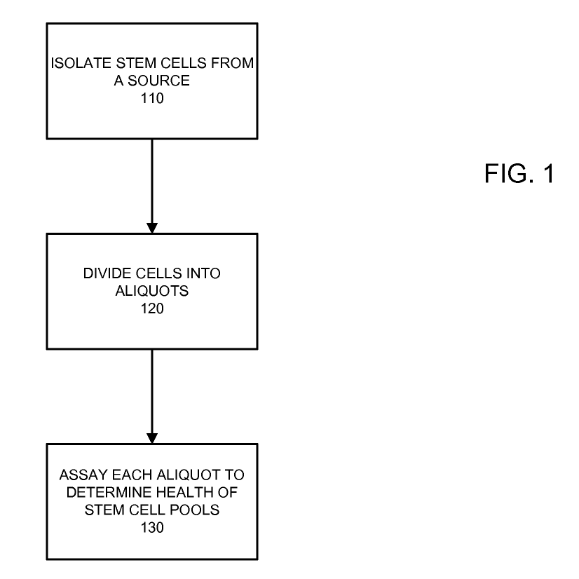

According to embodiments and as illustrated in FIG. 1, a process for selection of pristine stem cells is disclosed. In operation 110, stem cells are isolated from a stem cell source. According to embodiments, the source of stem cells is an autologous source in cases where the cells are going to be used as a therapy for a patient. Sources of stems cells include, for example, fibroblasts, hair follicles, intestinal crypts, testes, egg follicles, etc. Other sources of stem cells include, for example, cord blood, placental cells, or embryonic sources. Adult, somatic stem cells from a variety of tissue sources are also contemplated, including from blood, bone marrow, skin, hair follicles, liver, intestinal crypts, muscle satellite cells, adipose tissue, endothelial cells, and other sources of cells that are able to divide and differentiate. Moreover, according to embodiments, any source, autologous or not, of totipotent, pluripotent, multipotent, oligopotent, and unipotent stem cells may be used according to this disclosure. A person of ordinary skill in the art will know and appreciate the sources of stem cells.

Isolated stem cells are then divided into MCSCP aliquots in operation 120. Each aliquot comprises at least one to hundreds of cells. According to embodiments, each aliquot comprises a single clonal stem cell pool, from which a plurality of stem cell pools are created one aliquot per stem cell pool (TSCP).

After each TSCP is established, at least one assay is performed to generate data relating to the health of each stem cell pool in operation 130. Assays include growth rate determination; determination of stress response (e.g., the gene expression and protein levels for various stress response genes); stressors may include, for example, oxidative stress (such as induced by exposure to high levels of oxygen or hydrogen peroxide), heat stress (such as higher or lower temperatures), DNA damage stress (such as produced by ionizing or UV radiation), etc.; mitochondria metabolism measurement; genome testing (including SNP evaluation or gene and promoter region DNA sequencing); and other relevant assays that provide data from which a determination of relative health of the stem cell pool may be made. Many assays, including assays not specifically enumerated but known to artisans to be probative of the health of a cell are completed as being assays suitable for the present disclosure.

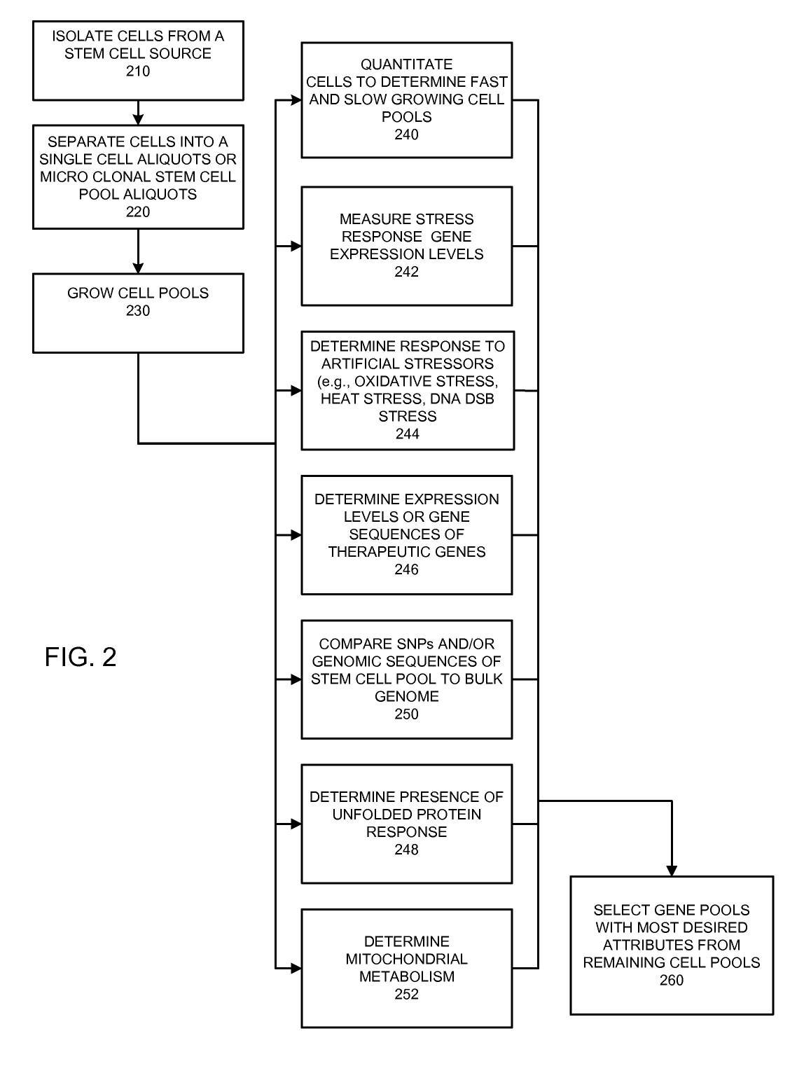

FIG. 2 illustrates an exemplary embodiment of a process for isolating pristine stem cells. It will be noted that the steps shown in FIG. 2 are in no particular order, and the assays are exemplary only and may be replaced with other assays performed in various orders and number. The exemplary process illustrated in FIG. 2 comprises first isolating existing stem cells from one of the various pools of stem cells within the body in operation 210. These pools comprise, according to embodiments, skin fibroblasts, hair follicle cells, intestinal crypt cells, muscle satellite cells, adipose tissue stem cells, testes cells, egg follicles, etc., and other sources as disclosed herein. A person of ordinary skill in the art will know and understand the specific sources of stem cells that are appropriate sources.

The isolated stem cells are separated into MCSCP aliquots each in operation 220 and the resultant aliquots are cultivated into TSCP. Thus, each resultant pool of cells has a specific individual genome mutation history. According to embodiments, each cell is cultivated as a cell culture, for example in multi-well cell culture plates (96-wells, 384-wells, etc.), in individual culture dishes, or in other related apparatus suitable for growing and maintaining stem cells. Specific environmental specifications for growing the stem cells will be determined on a case-by-case basis depending on the specific needs of each set of isolated stem cells according to well known protocols printed in the scientific literature or well known to artisans. Generally, the environment in which the stem cells are grown will both encourage growth without differentiation of the stem cells. Thus, each MCSCP gives rise to a “clonal” TSCP.

In operation 230 of FIG. 2, each stem cell pool is grown for a number of days until the stem cells in each pool are in sufficient number to carry out the assay steps for analysis. Assays may be begun once sufficient numbers are obtained to perform the necessary assays as well as to continue growth into numbers sufficient for specific therapeutic applications. The quantity of pristine stem cells required, and thus, the growth time required, varies with the cell type and specific therapeutic application.

According to embodiments, the number of cells within each pool is quantitated in operation 240. Pools having small numbers of cells (replicating slowly) are indicative of cells that are likely to contain highly defective genomes. According to embodiments, these pools are not selected. According to embodiments, pools with the highest cell numbers (replicating quickly) are likely to contain genomes which may have broken cell cycle (checkpoint) genes, are therefore potentially cancerous, and are consequently not selected as well, according to embodiments. According to embodiments, it is therefore desirable to select for stem cell pools that have moderate growth.

The criteria for “slowly” or “quickly” replicating may be dependent upon both the age of the individual or how defective the genomes are, and on an individual's personal genetic polymorphisms. Thus, the criteria for “slowly” or “quickly” may vary from individual to individual, according to embodiments.

According to embodiments, the stem cell pools are subjected to gene expression analysis in operation 242, according to embodiments. For example, stem cell pools showing stress response absent stressors are defective. Those pools with minimally measured cell stress response genes are therefore selected. For example, pools with low levels of the Endoplasmic Reticulum Stress Response (also known as the Unfolded Protein Response) which may be indicated by the cleaved (active) form of ERN1 (IRE1), active EIF2AK3 (PERK), low levels of spliced (active) XBP1 mRNA or protein, low levels of cleaved ATF6, low levels of ATF4 (CREB2) mRNA or protein, low levels of phosphoralated eIF2-alpha or other indicators of ER stress or unfolded proteins are desirable. Low levels of Growth Arrest and Damage-Inducible Genes PPP1R15A (GADD34), DDIT1 (GADD45A), GADD45B, GADD45G, and DDIT3 (CHOP/GADD153) are also desirable. According to embodiments, other stress state related genes that should have low levels of expression indicating a more pristine state include HSPA8 (HSC70), HSPA5 (BIP/GRP78), DNAJA2 (HSP40), DNAJB6 (HSP40), or CCT6. For example, a human equivalent the Affymetrix MOE430A chip of a gene chip with substantially similar or equivalent genes identifiers may be used to identify stem cell pools having low stress response gene expression. Artisans will recognize and may adapt the principles of the instant disclosure for genes that are indicative of a “pristine” genome state when expressed in either high, median, or low levels. However, at a minimum, activation states one or more of ERN1 (IRE1), EIF2AK3 (PERK), ATF6, XBP1, ATF4 and TRAF2 or MAP3K5 (ASK1) are useful in for determining ER stress level, according to embodiments.

According to embodiments, the genes listed in Table 1 are examples of genes useful in determining a pristine state, as will be understood by artisans. These genes include stress state related genes that may be used in conjunction with one or more gene chips as described above. Other genes may replace one or more genes in Table 1, or may be used to supplement one or more genes in Table 1. Generally, expression level, the presence of, or absence of the gene will be documented in the literature or known to be indicative of the health of a cell being assayed.

TABLE 1
Exemplary set of genes indicative of stem cell health.

ATF4 (CREB2)
ATF6 (cleaved)
RECQL3 (BLM)
CALR
CCT6
DDIT1 (GADD45A)
DDIT3 (CHOP/GADD153)
DNAJA2 (HSP40)
DNAJB6 (HSP40)
DNAJB9 (ERDJ4)
DNAJC10 (ERDJ5)
EIF2AKA3 (PERK)
eIF2-alpha (phosphorlated)
EDEM1
EDEM2
EDEM3
ERP70
ERN1 (IRE1)
GADD45B
GADD45G
GRP78 (HSPA5)
GRP94 (HSP90, HSPA90)
HERPUD1
SYVN1 (HRD1)
HSBA8 (HSC70)
HSPA5 (BIP/GRP78)
MARS
PDIA3 (GRP58)
PPP1R15A (GADD34)
RAD52
SSR1
SSR2
SSR3
SSR4
TRB3
XAB2
XBP1
XPB1 (spliced)
XRCC1

According to embodiments, stress response has been recently determined to have at least three differentially timed stress activators over time. Thus, the measurement of stress response may be conducted over a suitable time period to determine response with different stress response activators at different times. Depending on the stress activator, the applicable response will be checked at variable time intervals, according to embodiments.

According to embodiments, activation of genes may be determined by assaying for the presence of proteins present in the cells of a given stem cell pool. The presence of proteins may be confirmed using standard techniques, such as SDS-PAGE, antibody based detection techniques or mass spectroscopy, for example.

According to similar embodiments, quantitation of the expressed level of given genes may be assayed. Quantitation may be accomplished using known techniques, for example, RT-PCR techniques (to assay mRNA levels), gene chips, or other comparable methods for determining the genome state.

In operation 244, cell stress is induced to assay whether cellular stress response levels in the remaining pools are normal. Induced stress, include, for example, oxidative stress (e.g., hydrogen peroxide, high O₂, or glucose levels), heat stress (elevated or diminished temperatures), and DNA damage response stress (including double strand breaks from X-rays or gamma-rays or response to UV radiation, or a variety of genotoxic drugs, typically anticancer drugs with known DNA damage capabilities). Cells must activate the damage response genes normally activated in response to these stressors and die at normal rates when exposed to excessive levels of these stresses. This is necessary to test both the stress response and apoptosis capability pathways within the cells.

According to embodiments, another screening assay to determine “pristineness” of stem cells pools comprises a determination whether a cell is exhibiting an unfolded protein response in operation 246. The unfolded protein response measures changes in the state of cellular proteins. For example, assays using SDS-PAGE or ELISA, may be used to determine whether the cells of each stem cell pool have levels of the protein response proteins. Alternatively, or in addition, mRNA levels may be measured for unfolded response indicators using standard methods such a RT-PCR or gene chips. For example, high expression levels of unfolded protein response genes, such as ATF4, cleaved ATF6, or genes promoted by ATF4 or ATF6, may indicate cells undergoing an unfolded protein response. Because the unfolded protein response indicates corruption of at least one gene and often larger-scale genomic problems, stem cell pools undergoing the unfolded protein response may be discarded, according to embodiments. Measurement of unfolded protein response by targeting expression levels of genes, and their modification during the response which mediates the response may be accomplished using tests well understood by artisans, according to embodiments.

According to embodiments and as illustrated in FIG. 2 at operation 248, the normal expression levels or gene sequence in a selected set of therapeutic cell application genes is assayed. These may not include normal cell metabolism genes or genes required only in tissues not involved in the therapeutic application. Rather, they are genes essential to using the stem cells in the specific therapeutic application (heart genes for heart applications, muscle genes for muscle applications, skin genes for skin applications, etc.). Stem cell pools with significantly abnormal gene levels or sequences which vary from genome “standards” are discarded. According to embodiments, this could involve precision sequencing of several thousand gene sequences to be identified using current literature or the understanding of gene functions in specific cell types and organs.

According to embodiments, one assay compares small nucleotide polymorphisms (SNPs) of a bulk genome, such as the individual who is the source of the stem cells or a generic bulk or “standard” genome or if available an idealized genome, to each stem cell pool to determine the pristineness of the stem cell pools, according to embodiments and as illustrated in FIG. 2 in operation 250. The SNP sequences are compared between the bulk genome and the stem cell pools. Stem cell pools that differ the least from the bulk genome are deemed to be the healthiest, according to embodiments. Similarly, quantitation of each stem cell pool allows for a classification of the health of each stem cell pool as compared to the individual's bulk genome. In addition, selected genes involved in maintaining proper cellular division, esp. tumor suppressor and oncogenes, and vgenes involved in functions for specific therapeutic applications (neuronal genes for neuronal therapies, heart genes for heart therapies, hair production genes for hair replacement therapies, etc.) may have either their mRNA or genomic DNA sequenced to verify the genomic integrity of the TSCP.

According to embodiments, an additional selection criterion for the most pristine stem cells is determination of mitochondrial metabolism in operation 252. Too low a mitochondrial metabolism may result in deficient stem cell viability while too high a stem cell mitochondrial metabolism could potentially result in tumorigenesis. Therefore, testing and selecting for mitochondrial membrane potential, with methods known in the art, may be employed to eliminate stem cells with excessively low or high mitochondrial membrane potential.

In operation 260 the remaining stem cell pools may be used with high confidence of a “pristine” state for therapeutic applications, according to embodiments. As artisans will readily recognize, the assays for determination of the most pristine stem cell pools comprise a series of steps that select for the healthiest stem cell pools by eliminating pools known to have genetic defects. Other assays that generate data relating to a stem cell pool's health compared to other stem cell pools may be added or substituted with the assays disclosed herein to accomplish the same objectives disclosed herein. Moreover, the screening process can be expanded as technologies are developed and become increasingly cost effective.

According to embodiments, cells are isolated from a specific individual and are used for autologous therapies. Thus, because autologous cells are used, the therapies will have minimal negative side effects. The use of autologous stem cells provides significant advantages over cells derived from embryonic stem cells or umbilical cord stem cells from unrelated individuals. Such therapies which are problematic due to the destruction of the foreign stem cells by ones own immune system and the potential requirement for immunosuppressant drugs to prevent this. According to alternate embodiments, non-autologous cell are used.

The median or healthy stem cell pools may be smaller in the case of more elderly or unhealthy individuals, forcing the selection of stem cell pools having one or more undesirable indicia, such as rapidly replicating pools, according to embodiments. Generally, the stem cell pools that are deemed to be most pristine will be the stem cell pools having data indicating greatest overall health when compared to the other stem cell pools.

According to embodiments, the pools selected represent the “best of the best” cells from an individual. All other common stem cell protocols work with pools of cells that may have different genomes. This is a unique process to verify the best genomes available within sets of stem cells. Thus it can be applied to many, if not all stem cell therapeutic approaches.

According to embodiments, patients may select the thoroughness of the screening process based on the price they wish to pay or can afford to pay to have the stem cell pools assayed. As discussed above, the more screening steps that are conducted, the more confidence that the selected pool will be “pristine.”

Recently, the FDA has approved a number of treatments using stem cells or pluripotent cells to improve the function of diseased, scarred, or nonfunctioning organs, tissues, etc. For example, in one technology, autologous myoblasts are harvested from an individual, grown in culture, and then implanted into the individual's heart in areas of scar tissue or other damage. The myoblasts differentiate into cardiac muscle cells and improve function of the heart at the site of the damage, among other beneficial effects. A major limitation of these technologies currently is that the myoblasts are not screened in any way. Using the techniques disclosed herein, the stem cells in these types of technologies are screened to select only for the healthiest cells in the harvested stem cell pool, thereby ensuring the implanted cells are the best cells.

It is expressly contemplated that the methods disclosed herein are applicable to nearly any source of stem cells, from embryos to bone marrow derived stem cells to epithelial stem cells, etc. Moreover, the methods disclosed herein are applicable to these methods of stem cells to ensure that the healthiest or most pristine stem cells are used for whatever purpose the stem cells are being used. For example, autologous stem cells extracted from an individual for use in repair of body organs through injection of stem cells into the organs of the body, for example, are well adapted to the screening technique presented herein to screen for and ensure that the most healthy stem cells are used, thereby preventing downstream complications such as tumors.

Artisans will also readily recognize the utility as applied to non-stem cell cells. Non-stem cell cells may be selected, as desired, using the same tests disclosed herein to assay for the healthiest cells for use, for example, in reconstructive surgeries.

According to embodiments, high throughput devices may be employed as a platform to measure cell pool “pristineness.” According to embodiments, a single microarray may have incorporated therein a number of different tests or assays that are useful in determining the pristineness of the cell pool. For example, the genes responsible for the stress response or unfolded protein response, as described above, may be incorporated into a microarray and analyzed at the same time for expression levels, etc.

According to embodiments, other high-throughput devices are also contemplated for use with the present disclosure, as understood by artisans. For example, Nanostring Technology's (Seattle, Wash.) devices for direct multiplexed measurement of gene expression with color-coded probe pairs (26 Nature Biotechnology 317 (2008), the contents of which are incorporated by reference as if fully disclosed herein) is an appropriate platform for such high-throughput measurements.

According to embodiments, one or more kits of parts are disclosed. The kits of parts contain contents for performance of at least one of the methods herein disclosed. According to embodiments, kits of parts include devices for harvesting stem cells, dividing the stem cells into aliquots, and assaying the resulting stem cell pools to determine the healthiest stem cell pools. Assay devices may include, for example, high throughput devices, such as gene chip or protein assay arrays or other devices for testing many stem cell pools simultaneously, or for performing many assays on a stem cell pool simultaneously, or both.

The kits possibly include also compositions comprising reagents for specific assays, identifiers of a biological event, or other compounds identifiable by a person skilled upon reading of the present disclosure. The term “identifier” refers to a molecule, metabolite or other compound, such as antibodies, DNA or RNA oligonucleotides, able to discover or determine the existence, presence, or fact of or otherwise detect a biological event or cellular state under procedures identifiable by a person skilled in the art; exemplary identifiers are antibodies, exemplary procedures are microarray experiments and DNA sequencing to assay RNA or DNA, mass spectroscopy or protein/carbohydrate binding experiments to assay proteins, or more macro scale microscopic (visual) examination of the quality of the stem cells potentially assisted by fluorescent probes, or other procedures as described herein.

The kit may also comprise devices and reagents for creating reporting molecules or visualizing/quantifying the results of each assay, for example fluorescent markers, radiomarkers, and the like, as well as devices for visualization, etc.

While the devices and methods have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
obtaining stem cells from a stem cell source within an organism;
separating and growing aliquots of stem cells to form a plurality of stem cell pools;
assaying the health of each stem cell pool by testing each stem cell pool with a plurality of assays that generate data related to the health of each stem cell pool; and
selecting at least one stem cell pools for therapeutic applications based on the data.

2. The method of claim 1, wherein at least one of the plurality of assays includes determining the rate of growth of each stem cell pools.

3. The method of claim 1, wherein at least one of the plurality of assays includes determining whether at least one stem cell pool is undergoing an unfolded protein response.

4. The method of claim 1, wherein at least one of the plurality of assays comprises comparing at least one of single nucleotide polymorphisms, mRNA, or genomic DNA sequences from a bulk genome with those from stem cell pools.

5. The method of claim 1, wherein at least one of the plurality of assays comprises determining the metabolic state of the mitochondria in the stem cell pools.

6. The method of claim 1, wherein at least one of the plurality of assay includes determination of the expression levels for at least one gene related to a stress response.

7. The method of claim 6, wherein the gene comprises at least one of ATF4 (CREB2), ATF6 (cleaved) REQL3 (BLM), CALR, CCT6, DDIT1 (GADD45A), DDIT3 (CHOP/GADD153), DNAJA2 (HSP40), DNAJB6 (HSP40), DNAJB9 (ERDJ4), DNAJC10 (ERDJ5), EIF2AKA3 (PERK), eIF2-alpha (phosphorylated), EDEM1, EDEM2, EDM3, ERP70, ERN1 (IRE1), GADD45B, GAD45G, GRP78 (HSPA5), GRP94 (HSP90, HSPA90), HERPUD1, SYVN1 (HRD1) HPSBA8 (HSC70), HSPA5 (BIP/GRP78), MARS, PDIA3 (GRP58), PPP1R15A (GADD34) RAD52 SSR1, SSR2, SSR3, SSR4, TRB3, XAB2, XBP1, XBP1 (spliced), XRCC1.

8. The method of claim 6, wherein at least one of the plurality of assays includes determination of the expression level for at least one cell cycle checkpoint gene, tumor suppressor gene, oncogene, or unfolded protein response gene.

9. The method of claim 8, wherein the unfolded protein response (endoplasmic reticulum stress response) genes or proteins include the cleaved (active) form of ERN1 (IRE1), active EIF2AK3 (PERK), low levels of spliced (active) XBP1, low levels of cleaved ATF6, low levels of ATF4 (CREB2) mRNA or protein, low levels of phosphoralated eIF2-alpha or the Growth Arrest and Damage-Inducible genes PPP1R15A (GADD34), DDIT1 (GADD45A), GADD45B, GADD45G, and DDIT3 (CHOP/GADD153).

10. The method of claim 6, wherein at least one of the plurality of assay includes determination of the expression levels for at least an unfolded protein response gene.

11. A product by the process of claim 1.

12. A composition comprising:
at least one healthy stem cell pool;
wherein the health of each stem cell pool is derived from data from a plurality of assays used to generate data to assess the health of each stem cell pool and a determination of the health of each stem cell pool made from the data;
wherein a sample of stem cells is obtained, and the stem cells in the stem cell sample are divided in a plurality of aliquots, and each aliquot is grown into at least one stem cell pool.

13. The composition of claim 12, wherein at least one of the plurality of assays includes determining the rate of growth of each stem cell pools.

14. The composition of claim 12, wherein at least one of the plurality of assays includes determining whether at least one stem cell pool is undergoing an unfolded protein response.

15. The composition of claim 12, wherein at least one of the plurality of assays comprises comparing single nucleotide polymorphisms from a bulk genome to single nucleotide polymorphisms from stem cell pools.

16. The composition of claim 12, wherein at least one of the plurality of assays comprises determining the metabolism of the mitochondria in the stem cell pools.

17. The composition of claim 12, wherein at least one of the plurality of assays includes determination of the expression levels for at least one gene related to a stress response.

18. The composition of claim 17, wherein the gene comprises at least one of ATF4 (CREB2), ATF6 (cleaved) REQL3 (BLM), CALR, CCT6, DDIT1 (GADD45A), DDIT3 (CHOP/GADD153), DNAJA2 (HSP40), DNAJB6 (HSP40), DNAJB9 (ERDJ4), DNAJC10 (ERDJ5), EIF2AKA3 (PERK), eIF2-alpha (phosphorylated), EDEM1, EDEM2, EDM3, ERP70, ERN1 (IRE1), GADD45B, GAD45G, GRP78 (HSPA5), GRP94 (HSP90, HSPA90), HERPUD1, SYVN1 (HRD1) HPSBA8 (HSC70), HSPA5 (BIP/GRP78), MARS, PDIA3 (GRP58), PPP1R15A (GADD34) RAD52 SSR1, SSR2, SSR3, SSR4, TRB3, XAB2, XBP1, XBP1 (spliced), XRCC1

19. The composition of claim 12, wherein at least one of the plurality of assays includes determination of the expression levels for at least a cell checkpoint gene.

20. The composition of claim 19, wherein the cellular checkpoint gene comprises at least one of the cleaved (active) form of ERN1 (IRE1), active EIF2AK3 (PERK), low levels of spliced (active) XBP1, low levels of cleaved ATF6, low levels of ATF4 (CREB2) mRNA or protein, low levels of phosphoralated eIF2-alpha or the Growth Arrest and Damage-Inducible genes PPP1R15A (GADD34), DDIT1 (GADD45A), GADD45B, GADD45G, and DDIT3 (CHOP/GADD153).

21. The composition of claim 12, wherein at least one of the plurality of assay includes determination of the expression levels for at least an unfolded protein response gene.

22. A kit of parts comprising:
reagents and devices for performing a plurality of assays that produce data related to the health of stem cell pools.

23. The kit of parts of claim 22, further comprising reagents and devices for harvesting stem cells, dividing the harvested stem cells into stem cell pools, and growing the stem cell pools.
